(19) United States
(12) Patent Application Publication
(10) Pub. No.: US 2021/0223931 A1
(43) Pub. Date: Jul. 22, 2021

(54) TOUCH CONTROL DISPLAY DEVICE

(71) Applicant: WUHAN CHINA STAR OPTOELECTRONICS SEMICONDUCTOR DISPLAY TECHNOLOGY CO., LTD., Wuhan Hubei (CN)

(72) Inventor: Xiaoliang FENG, Wuhan (CN)

(73) Assignee: WUHAN CHINA STAR OPTOELECTRONICS SEMICONDUCTOR DISPLAY TECHNOLOGY CO., LTD., Wuhan Hubei (CN)

(21) Appl. No.: 15/733,926

(22) PCT Filed: Dec. 11, 2018
(86) PCT No.: PCT/CN2018/120418

§ 371 Date: Dec. 1, 2020

(30) Foreign Application Priority Data
Dec. 3, 2018 (CN) 201811467995.7

(51) Int. Cl. G06F 3/041; G06F 3/044

(52) U.S. Cl. CPC G06F 3/04164; G06F 3/0445; G06F 2203/04103; G06F 3/0412; G06F 3/0446

(57) ABSTRACT

The present disclosure provides a touch control display device. The display device includes a display panel, the first touch control electrode array arranged on the display panel, a first polarizing layer arranged on the first touch electrode array, and a second touch electrode array arranged on the first polarizing layer. The first touch control electrode array is insulated and separated from the second touch control electrode array through the first polarizing layer. The first touch control electrode array and the second touch control electrode array are respectively arranged on two sides of the first polarizing layer, such that the short circuit of the first touch control electrode array and the second touch control electrode array can be avoided, the touch control defects are prevented, the number of the film layers is reduced, the touch control structure is simplified, and the product thickness is reduced.

### BACKGROUND

### Field

The present disclosure relates to a technical field of display devices, and more particularly to a touch control display device.

### Background

With the development of the display technology, a plane display device, e.g., liquid crystal display (LCD), has the advantages of high image quality, better power saving, thin body, and a wide variety of application fields, the plane display device is widely applied to a mobile phone, a television, a personal digital assistant, a digital camera, notebook computers, and desktop computers, and becomes a mainstream of the display device.

The touch panel provides a novel human-computer interaction interface and is more direct and more humanized in use. The touch panel and the plane display device are integrated together to produce a touch control display device, such that the plane display device has a touch control function and information is inputted to the plane display device by fingers and a touch control pen, which are operated visually and conveniently.

Types of the touch display panel can be divided into a resistive type, a capacitive type, an optical type, and a sound wave type based on different sensing technologies and a mainstream touch technology is a capacitive type, where the capacitive type is divided into a self-capacitance type and a mutual capacitance type. The touch control display panel with the capacitive type in the market is mainly a mutual capacitance type, where the mutual capacitance can conduct the function of multi-point touch. The touch control display panel based on different structures can be divided into a type of “On Cell” which a touch control circuit covers a liquid crystal box, a type of “In Cell” which the touch control circuit is embedded in a liquid crystal box, and an add-on type. The type of “In Cell” has the advantages of low cost, ultra-thin, and narrow frame, and is mainly applied to high-end touch control products. The sensitivity of the type of “In Cell” is poor because manufacture processes, signal interference, and other factors of the in-cell touch technology are relatively difficult. At present, the touch display panel in the market is still in the add-on type. Advantages of the add-on type are high sensitivity and quick response speed, but the disadvantages of the add-on type are high cost and limited thickness of products. The “On Cell type” integrates the advantages of the add-on type and the “In Cell type, such that the sensitivity can be improved and the thickness of the panel can be reduced.

As shown in FIG. 1, a conventional on-cell touch control display device includes a display panel 100, a touch control layer 200 disposed on the display panel 100, a polarizing layer 300 disposed on the touch layer 200, and a protective film 400 disposed on the polarizing layer 300. As shown in FIG. 2, the touch control layer 200 includes a plurality of first electrode chains 1′ arranged at intervals and a plurality of second electrode chains 2′ which are arranged in parallel and insulated from the first electrode chain 1′ in an intersection manner. Each of the first electrode chains 1′ includes a plurality of first electrodes 11′ arranged at intervals and first connecting lines 12′ disposed at the intersection of the first electrode chain 1′ and the second electrode chain 2′, where two adjacent first electrodes 11′ are electrically connected through a first connecting line 12′. Each of the second electrode chain 2′ includes a plurality of second electrodes 21′ arranged at intervals and second connecting lines 22′ disposed at the intersections between the second electrode chains 2′ and the first electrode chains 1′, where two adjacent second electrodes 21′ are electrically connected through a second connecting line 22′, and the second connecting line 22′ is insulated from the first connecting line 12′. The first electrodes 11′, the second electrodes 21′, and the first connecting lines 12′ are disposed on the same film layer. The second connecting line 22′ is disposed on the other film layer different from the first connecting line 12′. An insulating layer is arranged between the film layer of the second connecting line 22′ and the film layer of the first connecting line 12′. The second connecting line 22′ is electrically connected with the second electrode 21′ by a through hole 30′ penetrating through the insulating layer. Because, on the touch layer 200, the first electrode 11′ and the second electrode 21′ are formed on the same film layer, such that the short circuit of the first electrode 11 and the second electrode 21′ and the risk of static damage are easily caused. The second electrode 21′ is connected by the second connecting line 22′ of the other film layer via the through hole 30′, thereby causing short circuits when being connected, more photo masks, and complicated manufacturing processes.

### SUMMARY OF THE DISCLOSURE

One objective of the present disclosure is to provide a touch control display device, such that the touch control structure is simplified, the touch control defects are prevented, and the product thickness is reduced.

In order to achieve the above-mentioned objective, the present disclosure provides a touch control display device. The touch control display device comprises a display panel, a first touch electrode array arranged on the display panel, a first polarizing layer arranged on the first touch control electrode array, and a second touch control electrode array arranged on the first polarizing layer, wherein the first touch control electrode array is insulated and separated from the second touch control electrode array through the first polarizing layer.

In an embodiment, the display panel is a liquid crystal display panel.

In an embodiment, the touch control display device further comprises a first a backlight source disposed on one side, away from the first touch electrode array, of the display panel, and a second polarizing layer disposed between the backlight source and the display panel, wherein a polarization axis of the second polarizing layer is perpendicular to a polarization axis of the first polarizing layer.

In an embodiment, the display panel is an organic light-emitting diode display panel.

In an embodiment, the touch control display device further comprises a protective film disposed on the second touch control electrode array.

In an embodiment, the first polarizing layer is attached to the first touch control electrode array through an optical transparent adhesive tape.

In an embodiment, the first touch electrode array comprises a plurality of first electrode chains arranged at intervals, and the second touch electrode array comprises a plurality of second electrode chains that are arranged at intervals and intersected with the first electrode chains.

In an embodiment, each of the first electrode chains comprises a plurality of first electrodes and first connecting lines connected with adjacent first electrodes, each of the second electrode chains comprises a plurality of second electrodes arranged at intervals and second connecting lines connected with the adjacent second electrodes, and the first connecting lines and the second connecting lines are disposed at intersection positions of the first electrode chains and the second electrode chains.

In an embodiment, the first electrodes 211 and the first connecting lines 212 are disposed on the same film layer and formed by a patterning process at the same time.

In an embodiment, the second electrodes and the second connecting lines are disposed on the same film layer and simultaneously formed by a patterning process.

The advantages of the present disclosures are as follows. The present disclosure provides a touch control display device. The display device includes a display panel, the first touch control electrode array arranged on the display panel, a first polarizing layer arranged on the first touch electrode array, and a second touch electrode array arranged on the first polarizing layer. The first touch control electrode array is insulated and separated from the second touch control electrode array through the first polarizing layer. The first touch control electrode array and the second touch control electrode array are respectively arranged on two sides of the first polarizing layer, such that the short circuit of the first touch control electrode array and the second touch control electrode array can be avoided, the touch control defects are prevented, the number of the film layers is reduced, the touch control structure is simplified, and the product thickness is reduced.

### BRIEF DESCRIPTION OF THE DRAWINGS

The following embodiments refer to the accompanying drawings for exemplifying specific implementable embodiments of the present disclosure in a suitable computing environment. It should be noted that the exemplary described embodiments are configured to describe and understand the present disclosure, but the present disclosure is not limited thereto.

FIG. 1 is a schematic diagram of a conventional touch control display device.

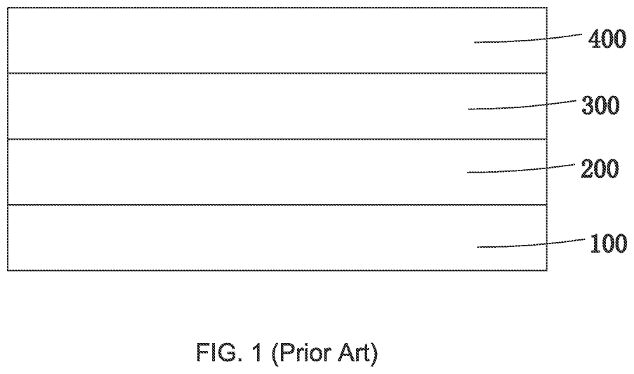

FIG. 2 is a schematic diagram of a touch layer of the conventional touch control display device.

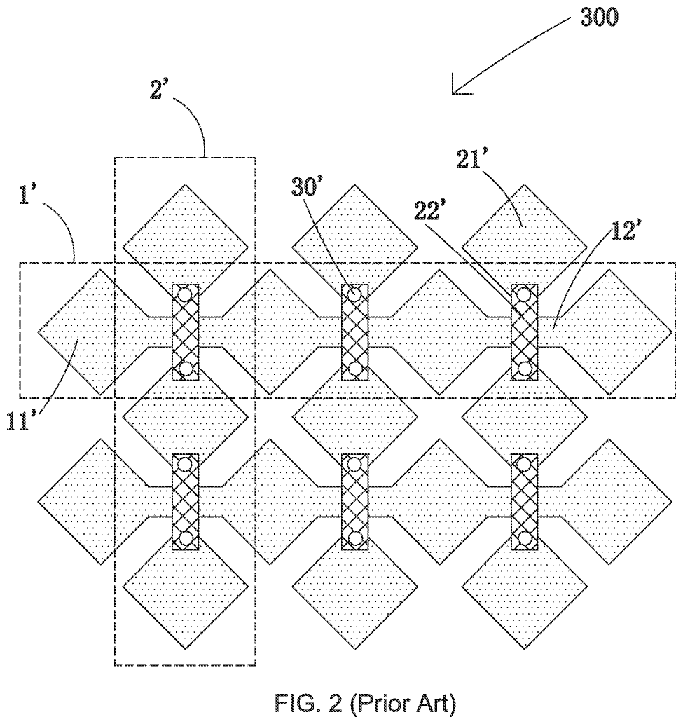

FIG. 3 is a side view of a touch control display device according to a first embodiment of the present disclosure.

FIG. 4 is a side view of a touch control display device according to a second embodiment of the present disclosure.

FIG. 5 is a top view of a first touch electrode array and a second touch control electrode array of a touch control display device according to an embodiment of the present disclosure.

### DETAILED DESCRIPTION OF THE PREFERRED EMBODIMENTS

The following embodiments refer to the accompanying figures for exemplifying specific implementable embodiments of the present disclosure in a suitable environment. It should be noted that the exemplary described embodiments are configured to describe and understand the present disclosure, but the present disclosure is not limited thereto. Directional terms, such as an upper side, a lower side, a front side, a back side, a left side, a right side, an inner side, an outer side, and a lateral side, mentioned in the present disclosure are only for reference. Therefore, the directional terms are used for describing and understanding rather than limiting the present disclosure. In the figures, units having similar structures are used for the same reference numbers.

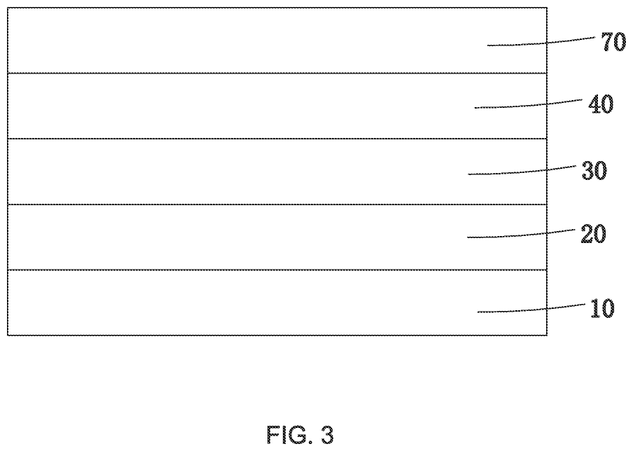

Referring to FIG. 3 to FIG. 5, the present disclosure provides a touch control display device. The display device includes a display panel 10, the first touch control electrode array 20 arranged on the display panel 10, a first polarizing layer 30 arranged on the first touch electrode array 20, and a second touch electrode array 40 arranged on the first polarizing layer 30. The first touch control electrode array 20 is insulated and separated from the second touch control electrode array 40 through the first polarizing layer 30.

In an embodiment, the first touch electrode array 20 and the second touch electrode array 40 are made of transparent materials.

Preferably, as shown in FIG. 3, in the first embodiment of the present disclosure, the display panel 10 is an organic light-emitting diode display panel.

Specifically, the organic light-emitting diode display panel includes a substrate and a packaging cover plate disposed on the substrate. the first touch electrode array 20 is arranged on one side, away from the substrate, of the packaging cover plate. A thin film transistor array and a first touch control electrode array are arranged on the substrate.

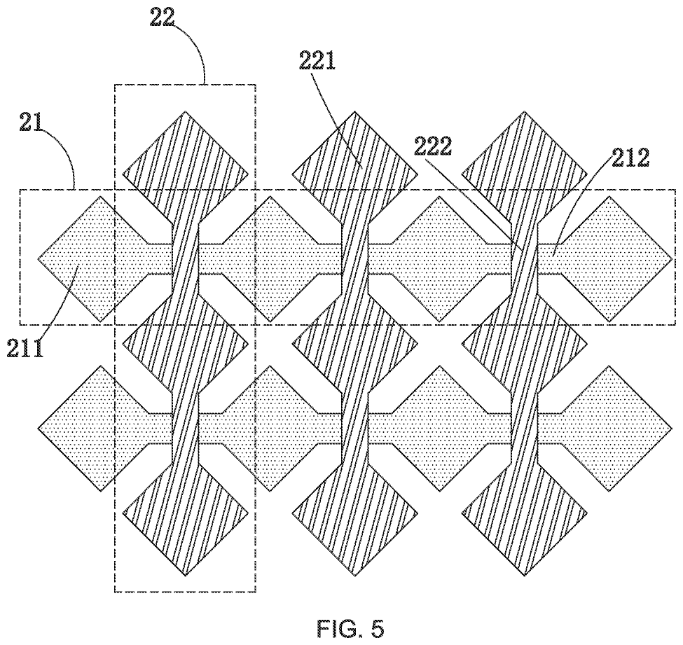

Specifically, as shown in FIG. 5, in a first embodiment of the present disclosure, the first touch electrode array 20 includes a plurality of first electrode chains 21 arranged at intervals, and the second touch electrode array 40 includes a plurality of second electrode chains 22 that are arranged at intervals and intersected with the first electrode chains 21.

Each of the first electrode chains 21 further includes a plurality of first electrodes 211 and first connecting lines 212 connected with the adjacent first electrodes 211. Each of the second electrode chains 22 includes a plurality of second electrodes 221 arranged at intervals and second connecting lines 222 connected with the adjacent second electrodes 221. The first connecting lines 212 and the second connecting lines 222 are disposed at the intersection positions of the first electrode chains 21 and the second electrode chains 22.

It should be noted that the first electrodes 211 and the first connecting lines 212 are disposed on the same film layer, and are formed by a patterning process at the same time. The second electrodes 221 and the second connecting lines 222 are disposed on the same film layer and are simultaneously formed by a patterning process. The touch control electrode, including a first touch control electrode array and a second touch control electrode array, in the present disclosure are manufactured by only two patterning processes. The number of corresponding photo masks is only two in comparison with conventional processes, thereby reducing the number of the photo masks obviously. Furthermore, the first electrodes 211 and the second electrodes 221 are disposed on different film layers, and a first polarizing layer 30 is arranged between the first electrodes 211 and the second electrodes 221 for insulating the first electrodes 211 from the second electrodes 221 to avoid short circuits between the first electrodes 211 and the second electrodes 221 in comparison with conventional processes. Moreover, the second electrodes 221 and the second connecting lines 222 are disposed on the same film layer and simultaneously formed through a patterning process, such that it is not required to connect the second electrodes 221 with the second connecting lines 222 by through holes, thereby avoiding connection defects caused by the through holes.

Specifically, in the first embodiment of the present disclosure, the touch control display device further includes a protective film 70 disposed on the second touch electrode array 40.

Preferably, in the first embodiment of the present disclosure, the first polarizing layer 30 is attached to the first touch electrode array 20 through an optical transparent adhesive tape.

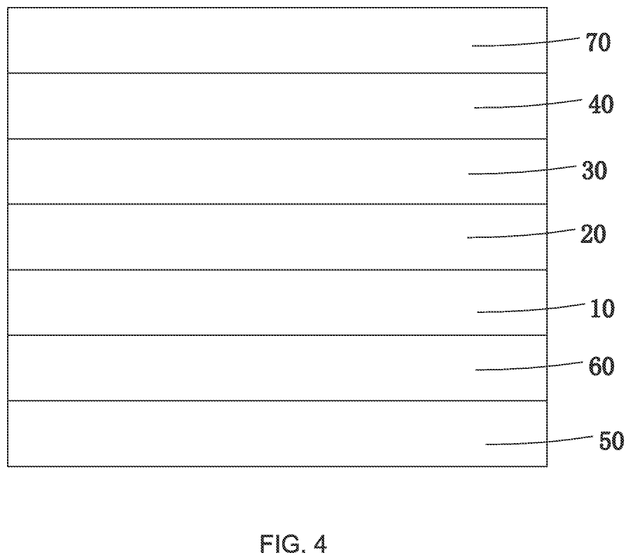

In addition, as shown in FIG. 4, in the second embodiment of the present disclosure, the display panel 10 is a liquid crystal display panel.

Specifically, the liquid crystal display panel includes an upper substrate, a lower substrate opposite to the upper substrate, and a liquid crystal layer disposed between the upper substrate and the lower substrate. The first touch electrode array 20 is formed on one side, away from the lower substrate, of the upper substrate.

In the second embodiment of the present disclosure, the touch control display device further includes a first a backlight source 50 disposed on one side, away from the first touch electrode array 20, of the display panel 10, and a second polarizing layer 60 disposed between the backlight source 50 and the display panel 10. A polarization axis of the second polarizing layer 60 is perpendicular to a polarization axis of the first polarizing layer 30.

Specifically, as shown in FIG. 5, in a second embodiment of the present disclosure, the first touch electrode array 20 includes a plurality of first electrode chains 21 arranged at intervals, and the second touch electrode array 40 includes a plurality of second electrode chains 22 that are arranged at intervals and intersected with the first electrode chains 21.

Each of the first electrode chains 21 further includes a plurality of first electrodes 211 and first connecting lines 212 connected with the adjacent first electrodes 211. Each of the second electrode chains 22 includes a plurality of second electrodes 221 arranged at intervals and second connecting lines 222 connected with the adjacent second electrodes 221. The first connecting lines 212 and the second connecting lines 222 are disposed at the intersection positions of the first electrode chains 21 and the second electrode chains 22.

It should be noted that the first electrodes 211 and the first connecting lines 212 are disposed on the same film layer, and are formed by a patterning process at the same time. The second electrodes 221 and the second connecting lines 222 are disposed on the same film layer and are simultaneously formed by a patterning process. The touch control electrode, including a first touch control electrode array and a second touch control electrode array, in the present disclosure are manufactured by only two patterning processes. The number of corresponding photo masks is only two in comparison with conventional processes, thereby reducing the number of the photo masks obviously. Furthermore, the first electrodes 211 and the second electrodes 221 are disposed on different film layers, and a first polarizing layer 30 is arranged between the first electrodes 211 and the second electrodes 221 for insulating the first electrodes 211 from the second electrodes 221 to avoid short circuits between the first electrodes 211 and the second electrodes 221 in comparison with conventional processes. Moreover, the second electrodes 221 and the second connecting lines 222 are disposed on the same film layer and simultaneously formed through a patterning process, such that it is not required to connect the second electrodes 221 with the second connecting lines 222 by through holes, thereby avoiding connection defects caused by the through holes.

Specifically, in the second embodiment of the present disclosure, the touch control display device further includes a protective film 70 disposed on the second touch electrode array 40.

Preferably, in the second embodiment of the present disclosure, the first polarizing layer 30 is attached to the first touch electrode array 20 through an optical transparent adhesive tape.

According to above-mentioned descriptions, the present disclosure provides a touch control display device. The display device includes a display panel, the first touch control electrode array arranged on the display panel, a first polarizing layer arranged on the first touch electrode array, and a second touch electrode array arranged on the first polarizing layer. The first touch control electrode array is insulated and separated from the second touch control electrode array through the first polarizing layer. The first touch control electrode array and the second touch control electrode array are respectively arranged on two sides of the first polarizing layer, such that the short circuit of the first touch control electrode array and the second touch control electrode array can be avoided, the touch control defects are prevented, the number of the film layers is reduced, the touch control structure is simplified, and the product thickness is reduced.

As is understood by a person skilled in the art, the foregoing preferred embodiments of the present disclosure are illustrative rather than limiting of the present disclosure. It is intended that they cover various modifications and similar arrangements be included within the spirit and scope of the present disclosure, the scope of which should be accorded the broadest interpretation so as to encompass all such modifications and similar structures.

What is claimed is:

1. A touch control display device, comprising a display panel, a first touch electrode array arranged on the display panel, a first polarizing layer arranged on the first touch control electrode array, and a second touch control electrode array arranged on the first polarizing layer, wherein the first touch control electrode array is insulated and separated from the second touch control electrode array through the first polarizing layer.

2. The touch control display device according to claim 1, wherein the display panel is a liquid crystal display panel.

3. The touch control display device according to claim 2, further comprising a first a backlight source disposed on one side, away from the first touch electrode array, of the display panel, and a second polarizing layer disposed between the backlight source and the display panel, wherein a polarization axis of the second polarizing layer is perpendicular to a polarization axis of the first polarizing layer.

4. The touch control display device according to claim 1, wherein the display panel is an organic light-emitting diode display panel.

5. The touch control display device according to claim 1, further comprising a protective film disposed on the second touch control electrode array.

6. The touch control display device according to claim 1, wherein the first polarizing layer is attached to the first touch control electrode array through an optical transparent adhesive tape.

7. The touch control display device according to claim 1, wherein the first touch electrode array comprises a plurality of first electrode chains arranged at intervals, and the second touch electrode array comprises a plurality of second electrode chains that are arranged at intervals and intersected with the first electrode chains.

8. The touch control display device according to claim 7, wherein each of the first electrode chains comprises a plurality of first electrodes and first connecting lines connected with adjacent first electrodes, each of the second electrode chains comprises a plurality of second electrodes arranged at intervals and second connecting lines connected with the adjacent second electrodes, and the first connecting lines and the second connecting lines are disposed at intersection positions of the first electrode chains and the second electrode chains.

9. The touch control display device according to claim 8, wherein the first electrodes and the first connecting lines are disposed on the same film layer and formed by a patterning process at the same time.

10. The touch control display device according to claim 8, wherein the second electrodes and the second connecting lines are disposed on the same film layer and simultaneously formed by a patterning process.
